(19) United States
(12) Patent Application Publication
(10) Pub. No.: US 2006/0065099 A1
(43) Pub. Date: Mar. 30, 2006

(54) Removable muting device for drums, cymbals and the like

(76) Inventor: James Martin Anderson, Corona, CA (US)

Correspondence Address: Ben E. Lofstedt, Esq., P.O. Box 4189, Fullerton, CA, 92831, US

(21) Appl. No.: 10/950,910

(22) Filed: Sep. 25, 2004

(51) Int. Cl. G10D 13/02

(52) U.S. Cl. 84/411 M

(57) ABSTRACT

A removable muting device for drums, cymbals, and the like, including a new and innovative layered combination formed of a pad of sponge rubber material having a top portion and a bottom portion, the bottom portion having a layer thereon of TYCO Adhesive No. 1724D which is a removable Acrylic adhesive having low peel, low tack, high shear and non-residue properties to allow the entire combination to be adhesively and removably affixed by pressure to a surface such as the drumstick-struck portions of drums and cymbals to mute the sound thereof when struck by a drumstick or the like.

### BACKGROUND OF THE INVENTION

1. Field of the Invention

The invention generally relates to muting or muffling devices for musical Instruments, and, more specifically, to percussive musical instruments such as drums, cymbals, and the like.

2. Description of the Prior Art

In order to become musically proficient in playing a musical instrument, a Musician must practice playing the musical instrument for lengthy periods of time. Musicians, especially youthful ones, have little or no choice but to practice on their musical instruments at home. Family and friends in the home may not always like to hear the dischordant sounds and misplaced tempo of a neophyte musician, especially those of a percussive character, such as drums and cymbals, but will usually tolerate such for reasonable periods of time. The next door neighbors, however, may not always be as kind, and will sometimes come over and request that the musician stop practicing, especially on the weekends, or in the later evening periods, or worse yet, may even notify the local police department and lodge a complaint about this “nusiance noise.”

In the prior art there is found a number of patents that utilize silicone, gels, and plastisol compounds in the manufacturing of thin-layer sheets for application and use on percussive instruments such as drums and cymbals for the purpose of dampening or silencing or “muting” such instruments.

Sound-muffling pads, particularly fabricated of felt or soft rubber, that are placed as covers directly on the drum playing head, such as shown in U.S. Pat. Nos. 2,078,004 and 3,453,924, must be fixed in place by braces or similar structures, and, further, are so relatively flimsy that a rigid base is required to hold them in position. Not only do the positioning braces and rigid base adversely interfere with the use of the muffling pads, but also contribute to unusual sounds and tones which affect and detract from the usefulness of this type of drum or cymbal practice pad.

Drummers have been using Neoprene impact pads to mute drums and cymbals. One of the most common item used is the “HQ Cymbal Silencer” which is attached to the cymbal stand bolt which passes through the cymbal and attaching it to the stand. The most sold and the most universal of this type and character is the “HQ Sound Off Pad System.”

Some of the other known prior art devices are found in U.S. Pat. No. 4,037,509 (Slomovits), U.S. Pat. No. 4,102,235 (Le Masters), U.S. Pat. No. 4,216,696 (Alexis, Jr.), U.S. Pat. No. 4,244,266 (Hardy), U.S. Pat. No. 4,325,280 (Hardy), U.S. Pat. No. 4,776,254 (Cruz), U.S. Pat. No. 5,561,254 (Huffer), U.S. Pat. No. 5,929,354 (Davis), U.S. Pat. No. 5,922,980 (Arteaga), and U.S. Pat. No. 5,959,227 (Shapiro).

U.S. Pat. No. 4,037,509 (Slomovits) relates to a practice cymbal cover for muting the sound of the cymbal when struck which utilizes a plurality of brace arms to retain a circularly-shaped thin pad in place.

U.S. Pat. No. 4,102,235 (Le Masters) relates to a cymbal or a drum muting device consisting of a weighted leather pad laid on the surface of the cymbal or drum head for practicing on the drum or cymbal without making the standard loud noise produced thereby during practicing on this type of percussive musical instrument.

U.S. Pat. No. 4,216,696 (Alexis, Jr.) relates to a cymbal stand and foot pedal assembly for producing and dampening percussive sounds with the cymbal. This device incorporates the unique feature of independently striking and dampening the cymbal through the use of a separate foot pedals actuatable by the same foot.

U.S. Pat. No. 4,244,266 (Hardy) teaches the use of a porous, pliable material with an adhesive layer on one surface which is used to attach the body to a drumhead membrane. The body may be annular, or of other shapes, and in a variety of different colors. One of the objects of this invention is to provide a drumhead deadening device which reduces the ringing phenomenon. Another object is to provide a drumhead deadening device which can be attached directly to the drumhead membrane and will remain in place and attached thereto allowing it to be easily and readily carried by marching band members, and which can be attached quickly, easily and securely. It substantially mutes the intensity of the vibrations of the drum. The materials used to construct this drum muting device are foam rubber, polyester, or other suitable porous and pliable material attached to the drumhead membrance by an adhesive layer. According to this inventor, this drumhead deadening device can be manufactured from large sheets of foam rubber on which the adhesive layer is applied and a protective peel-away paper layer is placed over the adhesive layer. The use of a permanent adhesive layer is mentioned.

U.S. Pat. No. 4,325,280 (Hardy) is a continuation of now U.S. Pat. No. 4,244,266 (Hardy). The primary improvement is to attach the drumhead deadening device to the inside of the drumhead membrane to reduce the percussive sound.

U.S. Pat. No. 4,776,254 (Cruz) relates to a damper assembly of the type used to dampen or muffle the sound issuing from a cymbal when it is struck with a drumstick or like instrument in the normal fashion wherein a vibration and movement of the cymbal is stopped, by a clamping assembly thereby serving to dampen the sound issuing therefrom.

U.S. Pat. No. 5,561,254 (Huffer) There is disclosed herein a device for muffling or otherwise modifying the sound of a drum, cymbal or other such percussion instrument. The device comprises a sheet-like flexible body of a polymeric material which is configured to engage a vibratable surface of drum head or cymbal in an airtight relationship so as to establish a vacuum seal therewith. The seal serves to retain the body of polymeric material on the drum or cymbal, and the flexible polymeric material effectively absorbs and dampens vibrations. The polymeric material is preferably a gel-like body of cured plastisol, and preferably has a durometer rating in the range of 15-60. The polymeric body may be colored. In particular embodiments the device may be configured as a disk, and a number of relatively small diameter disks may be appropriately located about the perimeter of the drum. In other embodiments, the device may be a relatively large diameter disk which covers a major portion of the playing surface of the drum. In this embodiment, the polymeric body is struck directly and functions to mute the volume of the drum. In other embodiments, the device may be a ring-like member.

U.S. Pat. No. 5,929,354 (Davis) As shown in FIG. 1, a pad 10 for practicing drumming constructed in accordance with the teachings of this invention comprises a single layer of silicone rubber with smooth, flat top and bottom surfaces 12 and 14. The silicone is preferably of the VMQ family with the following physical parameters:

| | | |
|---|---|---|
| 1. Modulus (@ 100% elongation) | 117-154 | psi |
| 2. Tensile Strength | 790-1015 | psi |
| (ASTM D412) | | |
| 3. Elongation @ 100% | 424-559 | |
| (ASTM D412) | | |
| 4. Durometer (Shore A) | 30-80 | |
| (ASTM D2240) | | |
| 5. Plasticity | 0 | |
| 6. Specific Gravity | 1.10-1.18 | |
| (ASTM D792) | | |

Material meeting these specifications is available from Freudenberg—NOK, Scottsburg, Ind., as compound LZ414. Most preferably, the material has a Durometer of 40, a tensile strength at the high end of the above range, and a specific gravity of 1.14. The thickness of the pad may be less than ¼ inch, and is preferably in the range of of 0.05 inches to 0.07 inches, and most preferably 1/16 inch. While FIG. 1 depicts the above embodiment as a square sheet, its shape is not critical to its functionality. The corners of the pad are conveniently rounded, and the pad may be molded in a variety of convenient shapes. Black silicone is presently preferred, although other colors are contemplated as well as clear silicone and silicone that is phosphorescent, fluorescent or otherwise luminescent. In order to optimize the pad's portability in combination with its utility for its intended purpose, its size should be between 3 and 6 inches across the striking and gripping surfaces. Most preferably, for a square pad, the pad is between 5¾ and 6 inches square, and approximately 60 grams in weight. Such a pad is so flexible that it can be wrapped around a drumstick or pair of drumsticks and held in s place with a rubber band or the like for transport virtually as easily as the drumsticks themselves can be transported. In use, the practice pad is placed on a flat support surface that is preferably also sold, smooth, clean and dry, and it is locked in place by simply pressing firmly and twisting with the palm of the hand. Practicing on the pad with drumsticks tightens the grip on the underlying surface, which, it will be noted, may be level but may alternatively be a vertical surface, e.g., a door, wall or cabinet.

U.S. Pat. No. 5,922,980 (Arteaga) relates to a sound muffling device for cymbal practice. However, there is no support or adhesive to connect the sound muffling device to the cymbals.

U.S. Pat. No. 5,959,227 (Shapiro) includes plates that mount to the cymbal from the stand using clamping methods.

However, none of the prior art muting devices incorporate the special and unique properties of TYCO Adhesive No. 1724D. This special adhesive has special properties which provides a pressure-sensitive backing for foam, rubber sponge, and similar materials for the temporary placement of components subject to high-shear. It is a removable acrylic adhesive having low peel, low tack, high shear and non-residue properties to allow the entire combination to be adhesively and removably affixed by pressure to a surface such as the drumstick-struck portions of drums and cymbals to mute the sound thereof when struck by a drumstick or the like. Among it's most important and primary characteristic is it's no residue feature. When used on the surface of a drum or cymbal it is extremely important to not put anything on such surfaces which leaves any residue. Any such residue left on these surfaces will result in a change in the musical characteristics of the drum or cymbal, and can change the color of the drum surface or the metal from which the cymbal is formed. Such color changes although undesirable in itself, is relatively secondary to any distortion in the playing surface due to impregnation of the drum playing surface with the residue of the adhesive or the molecular impregnation and/or changes in the metal alloy material from which the cymbals are fabricated. Such changes tend to distort the musical sounds of the drum material and the cymbals due to the lamination effect of the adhesive residue which tends to stiffen the musical playing surface and, with such lamination effect, negative changes in musical effects produced thereby. Even less desirable effects occur when the residue-lamination occurs only over a portion of the playing surface. The musical sound and quality of the sound produced is different in tonal resonation and sound if the drumstick or the cymbal striking element comes in contact with the residue-ladened surface left thereon vs. the playing surface which has no residue thereon. Even minor changes can produce significant and undesirable changes in the magnitude of the sound produce and the tonal quality and the reverbatory effects thereof, including the all important overtones.

### SUMMARY OF THE INVENTION AND OBJECTS

Fundamentally, there is described and disclosed herein a removable muting device for drums, cymbals, and the like, including a new and innovative layered combination formed of a pad of sponge rubber material having a top portion and a bottom portion, the bottom portion having a layer thereon of TYCO Adhesive No. 1724D, a removable Acrylic adhesive having low peel, low tack, high shear and non-residue properties which allows the entire combination to be adhesively and removably affixed by pressure to a surface such as the drumstick-struck portions of drums and cymbals to mute the sound thereof when struck by a drumstick or the like. The special low tack, non-residue adhesive features allow the muting device to be affixed contiguously with the top-facing portion of the drum or cymbal surface to allow the entire combination to be adhesively and removably affixed by pressure to a surface such as the drumstick-struck portions of drums and cymbals to mute the sound thereof when struck by a drumstick or the like.

It is one important and primary feature of the present invention to mute or muffle the drum, cymbal, or similar percussion musical instrument with a device having TYCO Adhesive 1724D with its unique low tack, non-residue characteristics.

Another significant and important feature and object of the instant invention is that the use thereof does not affect the tuning of the drum head or cymbal when removed because the TYCO Adhesive 1724D leaves no residue thereon.

Still yet another important and primary object of the invention disclosed and described herein is that its use does not leave any adhesive residue on the drum heads or cymbals following the removal therefrom.

It is one primary feature and object of the invention herein to be installed and removed very quickly.

Another important feature of the invention is that the use thereof does not greatly interfere with the feel or feedback through the hands of the musician playing the percussion instruments which are muted or muffled by the use of the invention herein.

It is yet a still further object of the invention to provide a muting or muffling device for percussive instruments, such as drums, cymbals, and the like, which is relatively low in cost.

Another important and significant feature of the present invention herein is that it is long wearing and durable.

One object and feature of the invention is that it is very light in weight and is readily transportable.

A still further feature and object of the present invention is that it can be readily and economically made in a variety of shapes, designs and colors to provide any number of new and novel visual effects when used.

It is yet another important and significant feature of the invention herein is that it is the first product designed to utilize a removable, non-residue adhesive for muting drum heads or cymbals.

One of the objects of the invention herein is that it is reuseable over and over again indefinitely.

Another important object of the invention herein is that both the sound and the vibrations are directly muted by the application of a muting device applied directly to the drum head or the metal surface of a cymbal.

It is one important and significant feature of the present invention to utilize lightweight sponge rubber in a range of from about three-thirty two seconds ( 3/32) of an inch thick to about one-sixteenth ( 1/16) of an inch thick of IV Neoprene Rubberite sponge such as manufacturer by Cypress Sponge, Costa Mesa, Calif., as a muting compound for cymbals wotj a layer of TYCO Adhesive 1724D thereunder versus the prior art muting devices use gum rubber or dense neoprene with adhesives which leave a residue which changes and distorts the amplitude of the sound, the tonal quality and the important overtones and reverbatory elements normally produced by such playing surfaces when struck.

The features of the present invention which are believed to be novel are set forth with particularity in the appended claims. Other claims and many of the attendant advantages will be more readily appreciated as the same becomes better understood by reference to the following detailed description and considered in connection with the accompanying drawings in which like reference symbols designate like parts throughout the figures.

### DESCRIPTION OF THE DRAWINGS

For a more complete understanding of the nature of the present invention, reference should be had to the following detailed description taken in connection with the accompanying drawings in which:

FIG. 1 depicts a drum with a drumhead and the invention secured to the outer surface of the drumhead.

FIG. 2 presents a cross-sectional view of the present muting device of the instant invention taken along Plane A-A of FIGS. 1, 4 and 5.

FIG. 3 is a perspective view of a circularly shaped configuration of the invention.

FIG. 4 is a top view of an oval shaped configuration of the invention.

FIG. 5 is a top view of a circularly shaped configuration of the invention.

FIG. 6 is an annular configuration of the present invention adhesively secured to a stand mounted cymbal.

FIG. 7 is a cross-sectional view of the invention disclosed herein taken along Plane B-B of FIG. 6.

FIG. 8 is a perspective view of an annular configuration of the present invention.

FIG. 9 is a perspective view of an irregularly shaped configuration of the present invention.

FIG. 10 is a perspective view of an star shaped configuration of the present invention.

FIG. 11 is a perspective view of an annular or ring-like configuration of the present invention.

### DETAILED DESCRIPTION OF THE PREFERRED EMBODIMENT

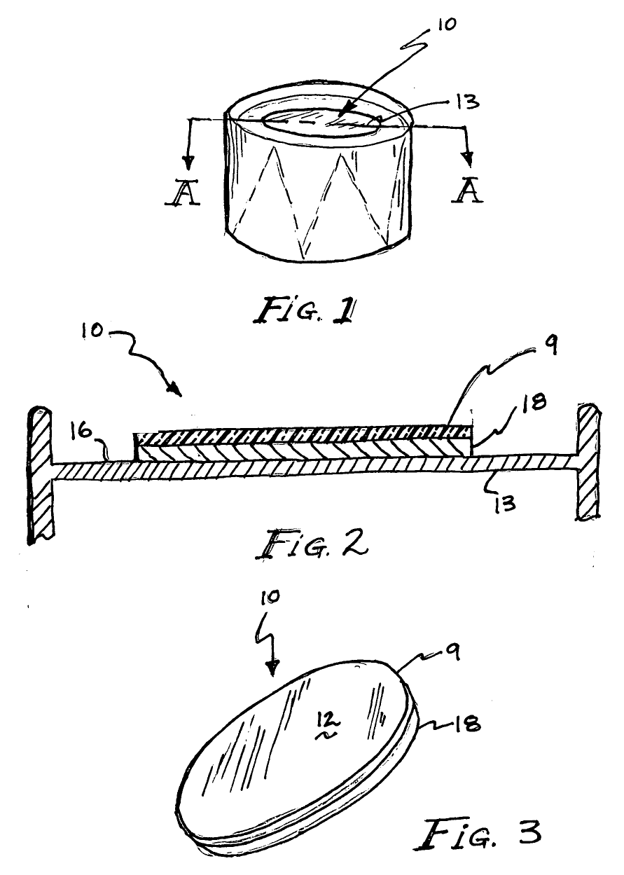

With continuing reference to the drawings herein, and, with special emphasis now to FIG. 1, there is shown and described herein one preferred embodiment of the present invention; namely, a removable muting device generally shown at 10 for drums, such as at 13 in FIG. 1, cymbals, such as 15 as shown in FIGS. 6 and 7, and the like, including a new and innovative layered combination formed of a pad of sponge rubber material 9 having a top portion 12 and a bottom portion 14, the bottom portion 14 having a layer of low tack, non-residue adhesive 18 thereon to allow the entire combination 10 to be adhesively and removably affixed by pressure to a surface such as the drumstick-struck portions of the drumhead (membrane) of a drum 13 or the top surface of a cymbal 15 to mute the sound thereof when struck by a drumstick 24 or the like.

The present invention 10, as illustrated in FIG. 2, is preferrably formed of a lightweight sponge rubber 9 in a range of from about three-thirty two seconds ( 3/32) of an inch thick to about one-sixteenth ( 1/16) of an inch thick of IV Neoprene Rubberite sponge such as manufactured by Cypress Sponge, Costa Mesa, Calif., as a muting compound for a cymbal 15 versus the prior art muting devices use gum rubber or dense neoprene.

The adhesive layer 18 in FIG. 2 is made of an substantially improved and different, non-residue, pressure-sensitive adhesive made by TYCO, 1400 Providence Highway, Norwood, Mass. 02062, namely, TYCO acrylic adhesive No. 1724D which is a significant improvement over the formerly used non-residue adhesive material as used by 3M company in its “Post-It” notes consisting of a differential tack adhesive technology to actually pressure fit the lightweight sponge material forming the muting pad 10 of the present invention onto the drum 13 membrane surface 16 as shown in FIGS. 1 and 2, and on the cymbal 15 of FIG. 7.

In FIG. 3 there is shown and depicted in perspective, the construction of the muting device of the present invention 10. The top surface 12 is formed of the lightweight sponge rubber 9 in a range of from about three-thirty two seconds ( 3/32) of an inch thick to about one-sixteenth ( 1/16) of an inch thick of IV Neoprene Rubberite sponge as previously described hereinbefore. A high-tack, pressure-sensitive, removable adhesive layer 18 which is preferably TYCO Adhesive No.1 724D, is secured to the underside of the foam rubber material 9.

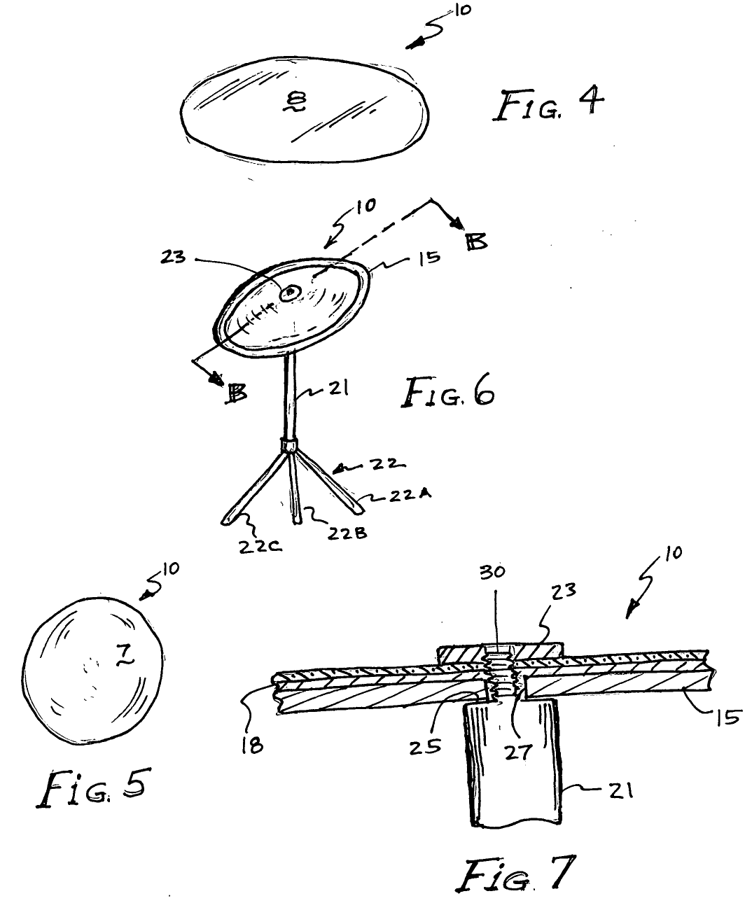

In FIG. 4, there is shown a top view 8 of an oval-shaped embodiment of the present invention 10.

In FIG. 5, there is illustrated a top view 7 of a circularly-shaped embodiment of the muting device of the instant invention 10.

In FIG. 6 a cymbal 15 is shown mounted via a post 21 to a stand 22 having a plurality of legs 22a, 22b, and 22c. The cymbal 15 is operatively secured to the top of the post 21 by means of a nut 23 which is typically threadably attached to the top of the post 21. The muting device 10 is adhesively secured to the upper portion of the cymbal 15 via the adhesive layer 18 as shown and illustrated in FIG. 7.

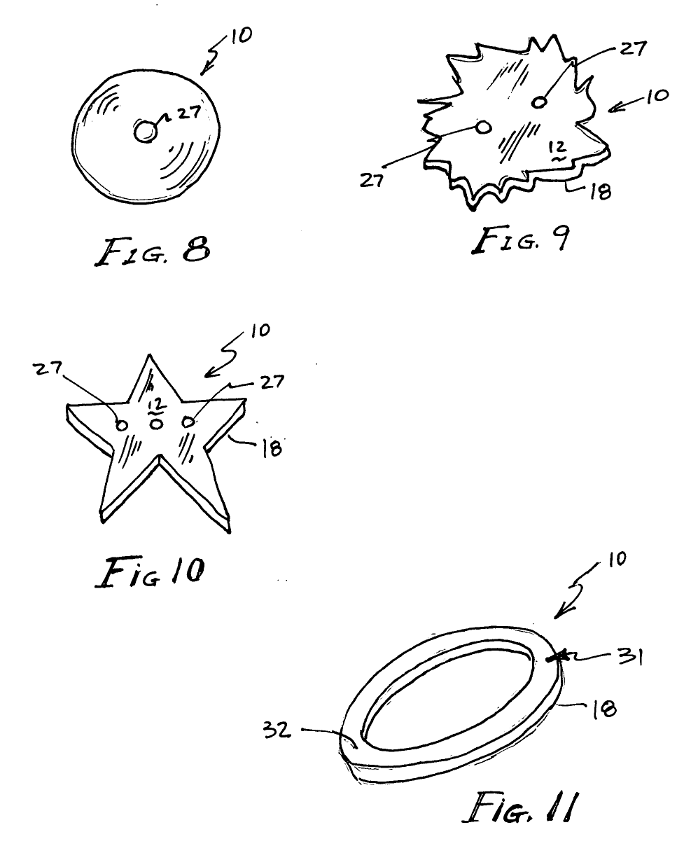

Turning now to FIG. 7, there is shown a cross-sectional view of the combination of the present invention 10 and the cymbal 15 with the muting device 10 adhesively secured to the cymbal 15 by the high-tack, pressure-sensitive adhesive layer 18. The cymbal 15 is mounted on top of the post 21 and rests on a shoulder 25 formed by the reduced diameter of the top portion of the post 21. A nut 23 is threadably mated to a threaded portion about the top of the post 21 to prevent the removal of the cymbal 15 therefrom. The annularly-shaped muting device 10 as shown and illustrated in FIG. 8 is adhesively mounted to the upper surface of the cymbal 15 by aligning the aperture 27 in the annularly-shaped muting device 10 over the nut 23. Pressure is applied by hand to the annularly-shaped muting device 10 to adhesively secure the muting device 10 to the cymbal 15. Alternatively desired shapes of the muting device 10 as shown in FIGS. 9 and 10 can also be used either in continuous solid form without any aperture or apertures therethrough, or with apertures 27 to permit the placement of the muting device 10 over the nut 23 and the top of the post 21 on which the cymbal 15 is operatively mounted.

With special emphasis now on FIG. 8, there is shown therein the muting device of the present invention 10 in annular form shown in a perspective view with a foam rubber layer 12 of the neoprene foam described hereinbefore with a high-tack, pressure sensitive adhesive layer 18. An aperture 27 through the muting device 10 provides for convenient mounting and removal from the center-post 30 mounted cymbal 15.

As shown and depicted in FIG. 9, there is illustrated the instant invention 10 with an irregularly contoured peripheral edge thereabout and formed of a foam rubber 12 layer of the character and type hereinbefore referenced and the non-residue, high-tack, pressure sensitive adhesive layer 18. Alternatively, the irregularly-shaped muting device 10 shown in FIG. 9 may have one or more apertures 27 therethrough for ease of mounting onto the cymbal 15.

Turning now to FIG. 10, there is depicted the muting device 10 bearing the unique characteristics of the invention herein in a five-pointed star configuration with the foam rubber 12 and the non-residue, high-tack, pressure sensitive adhesive layer 18. It should be noted that, alternatively, the star-shaped muting device 10 may have one or more apertures 27 therethrough for ease of mounting onto the cymbal 15.

TYCO differential tack adhesive provides a uniform tack and adhesive quality for uniformly adhesively securing the sound-dampening product of the invention described herein to the metal surface of the cymbals, either on the top or the underside thereof, to mute the sound produced when the cymbals are struck with a drumstick. The TYCO adhesive, No. 1724D, is pressures sensitive adhesive (“PSA”) which leaves no residue whatsoever on the metal surface of the cymbals.

In FIG. 10, there is shown and illustrated an annular ring 31 embodiment of the having the sponge rubber upper surface 32 and the adhesive layer 18 forming the muting device of the present invention for both drums and cymbals.

In FIG. 11 there is illustrated an annular or ring-like configuration 31 of the present invention 10 with the upper surface 32 of the sponge rubber material depicted with the adhesive layer 18 on the bottom of the configuration 31.

While the foregoing description represents preferred embodiments of the invention, it will be obvious to those skilled in the art that various changes and modifications may be made without departing from the spirit and scope of the invention which are specifically identified and referenced by the following appended claims.

What I claim as my invention is:

1. A sound muting device for percussion instruments, such as drumheads or cymbals, comprising:
(a) a membrane for producing sound when struck with a drumstick, an outer rim disposed on the periphery of said membrane;
(b) a device of pliable material for absorbing the vibrations produced by said membrane when struck with a drumstick, the device adapted for securement to the membrane within the outer rim thereof; and
(c) a removable, non-residue adhesive layer of TYCO Adhesive No. 1724D bonded to one side of the pliable material for removably attaching said device to said membrane.

2. The sound muting device of claim 1 wherein the adhesive layer does not leave a residue on the surface to which it was previously bonded following disengagement therefrom.

3. The sound muting device of claim 1 further comprising a removable layer of material co-extensive with the adhesive layer secured to one side of the device.

4. The sound muting device of claim 1 in which said device is in one of the following shapes: oval, circular, rectangular, triangular, or an irregular perimeter.

5. The sound muting device of claim 4 having at least one aperture therethrough.

6. The sound muting device of claim 1 in which the pliable material of said device is lightweight sponge rubber in a range of from about three-thirty two seconds ( 3/32) of an inch thick to about one-sixteenth ( 1/16) of an inch thick of IV Neoprene Rubberite sponge.

7. The sound muting device of claim 6 wherein the IV Neoprene Rubberite pliable material is that which is manufactured by Cypress Sponge, Costa Mesa, Calif.

8. The sound muting device of claim 1 in which said device is made of Neoprene sponge rubber in a range of from about three-thirty two seconds ( 3/32) of an inch thick to about one-sixteenth ( 1/16) of an inch thick.

9. The sound muting device of claim 1 in which said device is an annular shape.

10. A sound muting device for a drum, comprising:
(a) a drumhead membrane having an outer rim disposed on the periphery of said membrane,
(b) a device of non-porous, pliable material for absorbing the vibrations of said membrane;
(c) an aperture therein; and
(d) an non-residue-producing adhesive layer bonded to one side of the pliable material attaching said device to said membrane.

11. The sound muting device of claim 10 in which a layer of said adhesive is disposed on the bottom surface of said device.

12. The sound muting device of claim 11 further comprising a removable layer of material substantially co-extensive with the adhesive layer.

13. The sound muting device of claim 10 in which said device is made of sponge rubber in a range of from about three-thirty two seconds ( 3/32) of an inch thick to about one-sixteenth ( 1/16) of an inch thick of IV Neoprene Rubberite sponge material such as manufactured by Cypress Sponge, Costa Mesa, Calif.

14. The sound muting device of claim 1 wherein the adhesive is manufactured by TYCO.

15. The sound muting device of claim 14 wherein the adhesive is manufactured by TYCO, TYCO Adhesive No. 1724D which is pressure-sensitive but leaves no-residue on the surface to which it was temporarily pressure-sensitivity attached.

16. The sound muting device of claim 14 wherein the adhesive is manufactured by TYCO No. 1724 D which is of the pressure-sensitive, non-residue variety and bonds to Mylar material.

17. The sound muting device of claim 1 wherein the membrane is configured in the shape of a annulus.
